(19) United States
(12) Patent Application Publication
(10) Pub. No.: US 2026/0032574 A1
(43) Pub. Date: Jan. 29, 2026

(54) ON-DEMAND SYSTEM INFORMATION BLOCK 1 AVAILABILITY BASED CELL SELECTION

(71) Applicant: Lenovo (United States) Inc., Morrisville, NC (US)

(72) Inventors: Prateek Basu Mallick, Dreieich (DE); Alexander Golitschek Edler von Elbwart, Darmstadt (DE)

(73) Assignee: Lenovo (United States) Inc., Morrisville, NC (US)

(21) Appl. No.: 18/781,811

(22) Filed: Jul. 23, 2024

(51) Int. Cl. H04W 48/20; H04W 48/16

(52) U.S. Cl. CPC H04W 48/20; H04W 48/16

(57) ABSTRACT

An apparatus, operating in a radio resource control idle mode, selects from multiple candidate cells, a target cell to be a next serving cell for the apparatus. The apparatus starts, based on the target cell providing system information block 1 (SIB1) on an on-demand basis and in response to receiving a SIB1 request configuration for the target cell, a SIB1 request for the target cell based at least in part on the SIB1 request configuration for the target cell. The apparatus reselects, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continues to consider the target cell in future cell selection or reselection evaluation.

### TECHNICAL FIELD

The present disclosure relates to wireless communications, and more specifically to on-demand system information block 1 (SIB1) availability based cell selection.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication. The UE, operating in a radio resource control (RRC) idle mode, selects from multiple candidate cells, a target cell to be a next serving cell for the UE; starts, based on the target cell providing SIB1 on an on-demand basis and in response to receiving a SIB1 request configuration for the target cell, a SIB1 request for the target cell based at least in part on the SIB1 request configuration for the target cell; reselects, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation.

In some implementations of the method and apparatuses described herein, the SIB1 request configuration for the target cell includes a validity time or validity tag indicating how long the SIB1 request configuration is valid. Additionally or alternatively, to reselect the secondary candidate cell is to reselect the secondary candidate cell on a same frequency as the target cell in response to intra-frequency reselection being allowed. Additionally or alternatively, to reselect the secondary candidate cell is to reselect the secondary candidate cell on another frequency than the target cell in response to intra-frequency reselection not being allowed. Additionally or alternatively, the UE fails to receive the SIB1 request configuration for the target cell due to at least one of not being able to acquire the SIB1 request configuration within a threshold amount of time, a current serving cell of the UE being neither a network energy saving (NES) cell nor an anchor cell, or receiving SIB1 request configurations for one or more cells of the multiple candidate cells other than the target cell. Additionally or alternatively, the UE, in response to not receiving the SIB1 request configuration for the target cell, ignores the target cell until the SIB1 request configuration for the target cell is received or the SIB1 of the target cell is acquired. Additionally or alternatively, the UE, in response to not receiving the SIB1 request configuration for the target cell, bars the target cell for future cell selection or reselection for a threshold amount of time. Additionally or alternatively, the UE is unaware that the target cell provides the SIB1 on an on-demand basis, and the at least one processor is further configured to cause the UE to ignore the target cell until the SIB1 request configuration for the target cell is received or the SIB1 of the target cell is acquired. Additionally or alternatively, the target cell comprises one of the multiple candidate cells having a highest ranking or a one of the multiple target cells in a higher priority frequency than a frequency of a current serving cell for the UE.

Some implementations of the method and apparatuses described herein may further include a processor for wireless communication. The processor, operating in a RRC idle mode, selects from multiple candidate cells, a target cell to be a next serving cell for the processor; starts, based on the target cell providing SIB1 on an on-demand basis and in response to receiving a SIB1 request configuration for the target cell, a SIB1 request for the target cell based at least in part on the SIB1 request configuration for the target cell; reselects, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation.

In some implementations of the method and apparatuses described herein, the SIB1 request configuration for the target cell includes a validity time or validity tag indicating how long the SIB1 request configuration is valid. Additionally or alternatively, to reselect the secondary candidate cell is to reselect the secondary candidate cell on a same frequency as the target cell in response to intra-frequency reselection being allowed. Additionally or alternatively, to reselect the secondary candidate cell is to reselect the secondary candidate cell on another frequency than the target cell in response to intra-frequency reselection not being allowed. Additionally or alternatively, the processor fails to receive the SIB1 request configuration for the target cell due to at least one of not being able to acquire the SIB1 request configuration within a threshold amount of time, a current serving cell of the processor being neither an NES cell nor an anchor cell, or receiving SIB1 request configurations for one or more cells of the multiple candidate cells other than the target cell. Additionally or alternatively, the processor, in response to not receiving the SIB1 request configuration for the target cell, ignores the target cell until the SIB1 request configuration for the target cell is received or the SIB1 of the target cell is acquired. controller the processor, in response to not receiving the SIB1 request configuration for the target cell, bars the target cell for future cell selection or reselection for a threshold amount of time. Additionally or alternatively, the processor is unaware that the target cell provides the SIB1 on an on-demand basis, and the processor ignores the target cell until the SIB1 request configuration for the target cell is received or the SIB1 of the target cell is acquired. Additionally or alternatively, the target cell comprises one of the multiple candidate cells having a highest ranking or a one of the multiple target cells in a higher priority frequency than a frequency of a current serving cell for the processor.

Some implementations of the method and apparatuses described herein may further include a method performed by a UE, the method comprising: selecting from multiple candidate cells, a target cell to be a next serving cell for the UE; starting, based on the target cell providing SIB1 on an on-demand basis and in response to receiving a SIB1 request configuration for the target cell, a SIB1 request for the target cell based at least in part on the SIB1 request configuration for the target cell; and reselecting, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation.

In some implementations of the method and apparatuses described herein, the method further comprises: where reselecting the secondary candidate cell comprises reselecting the secondary candidate cell on a same frequency as the target cell in response to intra-frequency reselection being allowed.

### BRIEF DESCRIPTION OF THE DRAWINGS

FIG. 1 illustrates an example of a wireless communications system in accordance with aspects of the present disclosure.

FIG. 2 illustrates a time and frequency structure of an synchronization signal (SS)/physical broadcast channel (PBCH) block.

FIGS. 3 and 4 illustrate an example for the timing of candidate SS/PBCH blocks within an SS burst set.

FIG. 5 illustrates an example procedure for master information block (MIB) and system information block (SIB) transmission and relationships among SIBs.

FIG. 6 illustrates an example of a 4-step procedure for acquiring on-demand SIB1.

FIG. 7 illustrates an example of a UE in accordance with aspects of the present disclosure.

FIG. 8 illustrates an example of a processor in accordance with aspects of the present disclosure.

FIG. 9 illustrates an example of a NE in accordance with aspects of the present disclosure.

FIGS. 10 and 11 illustrate flowcharts of methods performed by a UE in accordance with aspects of the present disclosure.

FIG. 12 illustrates a flowchart of a method performed by a NE in accordance with aspects of the present disclosure.

### DETAILED DESCRIPTION

A network expends substantial energy in transmitting synchronization signal blocks (SSBs), PBCH containing MIB and SIB1. The SIB1 includes system parameters and configuration information that are used by UEs and/or other devices to communicate with a base station, such as a cell identity of a cell provided by the base station, scheduling information for other system information blocks, the format of downlink control information (DCI), and so forth. One technique for reducing energy usage in a cell (e.g., in a base station) is to transmit the SIB1 on an on-demand basis. Using such a technique, rather than transmitting the SIB1 at regular intervals, the base station transmits the SIB1 in response to a request for the SIB1.

Various issues can arise when transmitting the SIB1 on an on-demand basis. One such issue is that not all base stations support transmitting the SIB1 on an on-demand basis, and the UE may have difficulty quickly determining whether a particular cell provides SIB1 on an on-demand basis. Another issue is that the UE obtains or determines a SIB1 request configuration to determine how to submit a request for the SIB1, but the UE may have difficulty in obtaining the SIB1 request configuration.

In accordance with the techniques discussed herein, the UE determines that a target cell for selection or reselection (e.g., a highest ranked cell) does not provide SIB1 regularly. This determination is made, for example, from the MIB (e.g., the field ssb-SubcarrierOffset indicates that SIB1 is absent). However, the UE cannot determine that the target cell is an NES Cell that provides SIB1 only on an on-demand basis, e.g., the target cell does not regularly broadcast SIB1. In one or more implementations, the UE bars the target cell until the UE realizes that the target cell provides SIB1 on an on-demand basis, e.g., when the UE finds an anchor cell providing SIB1 request configuration for the target cell. In one example, if the UE fails to acquire the SIB1 request configuration for the target cell, the UE bars the target cell for a threshold amount of time (e.g., 300 seconds). The UE stops barring the target UE if the UE receives a SIB1 request configuration for the target cell and/or the UE acquires SIB1 of the target cell. Additionally techniques are also discussed herein to facilitate providing SIB1 on an on-demand basis, such as setting a validity duration for an SIB1 request configuration.

Accordingly, the techniques discussed herein allow a cell (e.g., a base station) to reduce energy usage (e.g., operate in a low energy mode) by transmitting SIB1 in response to a request (e.g., from a UE) for the SIB1 rather than transmitting the SIB1 at regular intervals. The techniques discussed herein allow the UE to successfully navigate scenarios and maintain communication with a cell in various situations, such as situations in which the UE identifies as a target cell (identified by the UE to be selected or reselected as the serving cell for the UE) a cell for which the UE cannot determine if the target cell provides SIB1 on an on-demand basis, the UE cannot obtain or determine a SIB1 request configuration for the target cell, and/or the UE cannot obtain a SIB1 for the target cell.

Aspects of the present disclosure are described in the context of a wireless communications system.

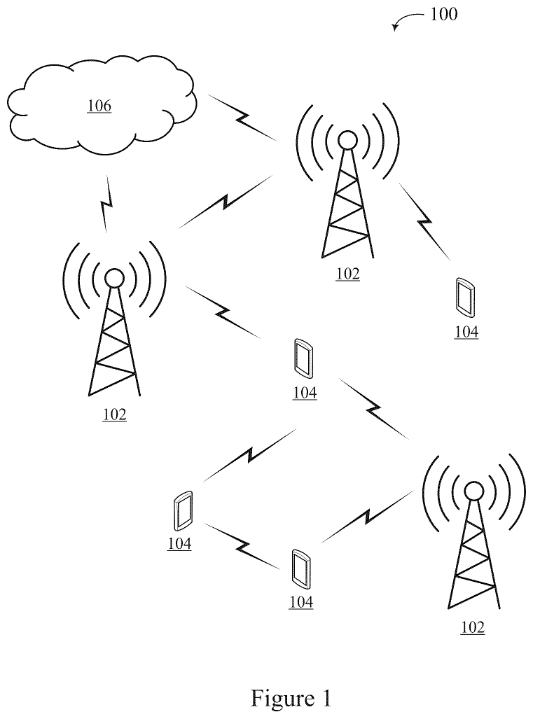

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

In some cases, a cell refers to a radio access node in communication with a base station or including a base station. A cell typically has a coverage area, which is a geographic area in which the cell provides wireless connectivity to devices within. Different cells may operate on defined frequencies or frequency bands, referred to as subcarriers. In some examples, a UE 104 establishes a wireless connection with a cell, and subsequently that cell may be referred to as a serving cell of the UE 104.

Reference is made herein to receiving or transmitting data, information, messages, and so forth. It is to be appreciated that other terms may be used interchangeably with receiving or transmitting, such as communicating, outputting, forwarding, retrieving, obtaining, and so forth.

Devices in the wireless communications system 100, such as NEs 102, expend substantial energy in transmitting SSBs, PBCH containing MIB, and SIB1). One technique for reducing energy usage in a cell (e.g., in a base station) is to transmit the SIB1 on an on-demand basis (so the UE request SIB1 when needed). Another technique for reducing energy usage in a cell (e.g., in a base station) is relying on an anchor cell as a proxy (e.g., for time-frequency synchronization and/or SIB1) for transmitting the SIB1.

Procedures and signaling methods to support on-demand SIB1 for UEs in idle or inactive mode are taken into consideration. The idle mode (e.g., RRC idle mode) refers to a dormant state of the UE where the UE is not actively engaged in communication with an NEs 102. These procedures and signaling methods include a triggering method by uplink wake-up-signal using an existing signal and/or channel, a wake-up-signal configuration provisioning to the UE (e.g., with no modification of SSB), Information exchange between NEs at least for the configuration of wake-up signal, or combinations thereof.

A UE 104 can determine if SIB1 is provided only on on-demand basis and thereby request for SIB1 to a NE 102. The techniques discussed herein describe handling some error scenarios, e.g., if the UE 104 cannot immediately determine if the cell in question provides SIB1 on an on-demand basis (or that it does not provide SIB1 at all). Similarly, the techniques discussed herein describe UE 104 behavior if the UE 104 cannot obtain or determine a SIB1 request configuration, how long an obtained SIB1 request configuration is considered valid, and so forth.

Emissions and energy consumption from different elements of a telecommunication system is adversely contributing to the climate. Besides, the operating expenses to run a telecommunication services are huge. In telecoms, a number of industry-specific factors rooted in countering rising network costs have further shaped efficiency efforts. A continued rise in mobile data traffic, estimated at 6.4 gigabytes (GB) per user per month in 2019 and forecast to grow threefold on a per-user basis over the next five years. Combined with the rising costs of spectrum, capital investment and ongoing RAN maintenance and/or upgrades, energy-saving measures in network operations are important. 5G New Radio (NR) offers a significant energy-efficiency improvement per gigabyte over previous generations of mobility. However, new 5G use cases and the adoption of mm Wave will require more sites and antennas. This leads to the prospect of a more efficient network that could paradoxically result in higher emissions.

A study on network energy saving in NR justifies the need for energy saving [3^{rd} generation partnership project (3GPP) technical report (TR) 38.864]. This study indicates that network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g., for extended reality (XR)), networks are becoming denser, using more antennas, larger bandwidths, and more frequency bands.

Energy consumption has become a key part of the operators' operating expenses. According to some estimates, the energy cost on mobile networks accounts for approximately 23% of the total operator cost. Most of the energy consumption comes from the radio access network and in particular from the active antenna unit (AAU), with data centers and fiber transport accounting for a smaller share. The power consumption of a radio access can be split into two parts: the dynamic part which is only consumed when data transmission or reception is ongoing, and the static part which is consumed all the time to maintain the necessary operation of the radio access devices, even when the data transmission or reception is not on-going.

Therefore, there was a need to study and develop a network energy consumption model especially for the base station (a UE power consumption model was already defined in 3GPP TR38.840), key performance indicators (KPIs), and an evaluation methodology and to identify and study network energy savings techniques in targeted deployment scenarios. The study investigated how to achieve more efficient operation dynamically and/or semi-statically and finer granularity adaptation of transmissions and/or receptions in one or more of network energy saving techniques in time, frequency, spatial, and power domains, with potential support and/or feedback from UE, potential UE assistance information, and information exchange and/or coordination over network interfaces.

The study not only evaluated the potential network energy consumption gains, but also assessed and balanced the impact on network and user performance, e.g., by looking at KPIs such as spectral efficiency, capacity, user perceived throughput (UPT), latency, UE power consumption, complexity, handover performance, call drop rate, initial access performance, service level agreement (SLA) assurance related KPIs, and so forth.

UEs can transmit physical random access channel (PRACH) to enable UE connectivity to the NEs. PRACH in 5G involves preamble transmission where a UE selects a random access preamble from a set of predefined preambles. These preambles can be of approximately two categories: Short Preamble and Long Preamble Format. The UE also selects a random sequence number for the preamble. After choosing the preamble and sequence number, the UE transmits the preamble on the PRACH.

Regarding synchronization signal/PBCH block (SS/PBCH block), cell search is the procedure for a UE to acquire time and frequency synchronization with a cell and to detect physical layer cell ID (PCI) of the cell. During cell search operations which are carried out when a UE is powered ON, mobility in connected mode, idle mode mobility (e.g. reselections), inter-RAT mobility to NR system etc., the UE uses NR synchronization signals and PBCH to derive the necessary information required to access the cell. Two types of synchronization signals are defined for NR; primary synchronization signal (PSS) and the secondary synchronization signal (SSS). The SS/PBCH block consists of PSS, SSS and physical broadcast channel (PBCH). Synchronization signals can also be used by the UE for reference signal received power (RSRP) and reference signal received quality (RSRQ) measurements.

Regarding PCI, there are 1008 unique PCIs defined in 5G NR and the 1008 NR PCIs are divided into 336 unique PCI groups, with each group consisting of three different identities. A PCI of a cell can be calculated using:

$${N}_{ID}^{Cell} = 3 * {N}_{ID}^{( 1 )} + {N}_{ID}^{( 2 )} where {N}_{ID}^{( 1 )} ∈ \{ 0 , 1 , … , 335 \} and {N}_{ID}^{( 2 )} ∈ \{ 0 , 1 , 2 \}$$

The UE can derive PCI group number N_{ID}⁽¹⁾ from SSS and physical-layer identity N_{ID}⁽²⁾ from PSS.

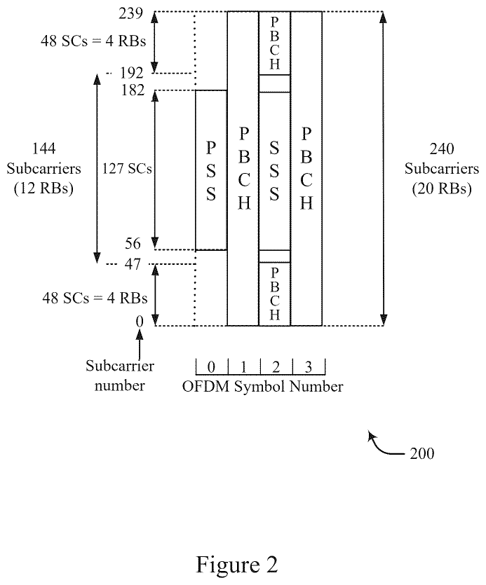

FIG. 2 illustrates a time and frequency structure 200 of an SS/PBCH block. In the time and frequency structure 200, PSS, SSS and PBCH are together in consecutive OFDM symbols and each SS/PBCH block occupies 4 OFDM symbols in the time domain and spread over 240 subcarriers (20 RBs) in the frequency domain. Further, PSS occupies the first OFDM symbol and span over 127 subcarriers, and SSS is located in the third OFDM symbol and span over 127 subcarriers. There are 8 unused subcarriers below SSS and 9 unused subcarriers above SSS. PBCH occupies two full OFDM symbols (second and fourth) spanning 240 subcarriers and in the third OFDM symbol spanning 48 subcarriers below and above SSS. This results in PBCH occupying 576 subcarriers across three OFDM symbols (240+48+48+240=576). PBCH demodulation reference signal (DM-RS) occupies 144 REs which is one-fourth of total REs and remaining for PBCH payload (576−144=432 REs).

Table 1 presents a summary of frequency resources occupied by SS/PBCH block, including PSS, SSS, PBCH and DM-RS for PBCH. The complex-valued symbols corresponding to resource elements denoted as ‘Set to 0’ in Table 1 are set to zero. As can be seen from Table 1, the location of PBCH DM-RS depends upon PCI (v=N_{ID}^{cell} mod 4) of the cell, e.g., PCI already determined by the UE using PSS/SSS.

TABLE 1

| | OFDM symbol | |
|---|---|---|
| | number ‘l’ | |
| | relative to | |
| | the start | Subcarrier number ‘k’ |
| Channel or | of an | relative to the start |
| Signal | SS/PBCH block | of an SS/PBCH block |
| PSS | 0 | 56, 57, . . . , 182 |
| SSS | 2 | 56, 57, . . . , 182 |
| Set to ‘0’ | 0 | 0, 1, . . . , 55, 183, 184, . . . , 239 |
| | 2 | 48, 49, . . . , 55, 183, 184, . . . , 191 |
| PBCH | 1, 3 | 0, 1, . . . , 239 |
| | 2 | 0, 1, . . . , 47, |
| | | 192, 193, . . . , 239 |
| DM-RS for | 1, 3 | 0 + ν, 4 + ν, 8 + ν, . . . , 236 + ν |
| PBCH | 2 | 0 + v, 4 + v, 8 + v, . . . , 236 + v |
| | | 192 + ν, 196 + ν, . . . , 236 + v |

Regarding SSB details in time domain, each SS/PBCH block spans across 4 OFDM symbols in the time domain and an SS/PBCH block is periodically transmitted with a periodicity of 5 ms, 10 ms, 20 ms, 40 ms, 80 ms or 160 ms. While longer SS/PBCH block periodicities enhances network energy performance, the shorter periodicities facilitate faster cell search for UEs. A UE can assume a default periodicity of 20 ms during initial cell search or idle mode mobility.

Regarding an SS burst set, to enable beam-sweeping for PSS/SSS and PBCH, SS burst sets are defined. An SS burst set includes a set of SS/PBCH block, and each SS/PBCH block can be transmitted on a different beam. Further, an SS burst set can include one or more SS/PBCH blocks. SS/PBCH blocks in the SS burst set are transmitted in time-division multiplexing fashion and an SS burst set can be confined to a 5 ms window and is either located in a first half or in a second half of a 10 ms radio frame. The network sets the SS/PBCH block periodicity via RRC parameter ssb-PeriodicityServingCell which can take values in the range {5 ms, 10 ms, 20 ms, 40 ms, 80 ms, 160 ms}. The maximum number of candidate SS/PBCH blocks (Lₘₐₓ) within an SS burst set depends upon the carrier frequency/band such as shown in Table 2 below.

TABLE 2

| | Max. No. of Candidate SS/PBCH blocks |
|---|---|
| Carrier Frequency | within SS Burst Set (Lₘₐₓ) |
| f_{c} ≤ 3 GHz* | 4 |
| 3 GHz* < f_{c} ≤ 6 GHz | 8 |
| f_{c} > 6 GHz | 64 |

*SCS = 30 kHz case: for paired spectrum, 3 GHz, for unpaired spectrum, 2.4 GHz is used

Within a 5 ms half frame, the starting OFDM symbol index for a candidate SS/PBCH block within SS burst set depends upon subcarrier spacing (SCS) and carrier frequency/band summarized in Table 3 below. See section 4.1 from 3GPP Technical Specification (TS) 38.213 for full details.

TABLE 3

| | OFDM starting | f_{c} ≤ 3 | 3 GHz* < f_{c} ≤ 6 | |
|---|---|---|---|---|
| | symbols of the | GHz* | GHz | f_{c} > 6 GHz |
| SCS | candidate SSBs | Lₘₐₓ = 4 | Lₘₐₓ = 8 | Lₘₐₓ = 4 |
| CaseA: | {2, 8} + 14n | n = 0, 1 | n = 0, 1, 2, 3 | NA |
| 15 | | {2, 8, 16, 22} | {2, 8, 16, 22, 30, 36, | |
| kHz | | | 44, 50} | |
| CaseB: | {4, 8, 16, 20} + 28n | n = 0 | n = 0, 1 | NA |
| 30 | | {4, 8, 16, 20} | {4, 8, 16, 20, 32, 36, | |
| kHz | | | 44, 48} | |
| CaseC: | {2, 8} + 14n | n = 0, 1 | n = 0, 1, 2, 3 | NA |
| 30 | | {2, 8, 16, 22} | {2, 8, 16, 22, 30, 36, | |
| kHz | | | 44, 50} | |
| CaseD: | {4, 8, 16, 20} + 28n | NA | NA | n = 0, 1, 2, 3, 5, |
| 120 | | | | 6, 7, 8, 10, 11, 12, |
| kHz | | | | 13, 15, 16, 17, 18 |
| | | | | {4, 8, 16, 20 . . . |
| | | | | 508, 512, 520, 524} |
| CaseE: | {8, 12, 16, 20, 32, | NA | NA | n = 0, 1, 2, 3, 5, 6, 7, 8 |
| 240 | 36, 40, 44} + 56n | | | {8, 12, 16, 20 . . . |
| kHz | | | | 480, 484, 488, 492} |

*SCS = 30 kHz case: for paired spectrum, 3 GHz, for unpaired spectrum, 2.4 GHz is used Entries within curly brackets denote OFDM starting symbols for the candidate SS/PBCH blocks

Note that when the network is not using beam forming, it may transmit only one SS/PBCH block and hence there can only be one SS/PBCH block starting position.

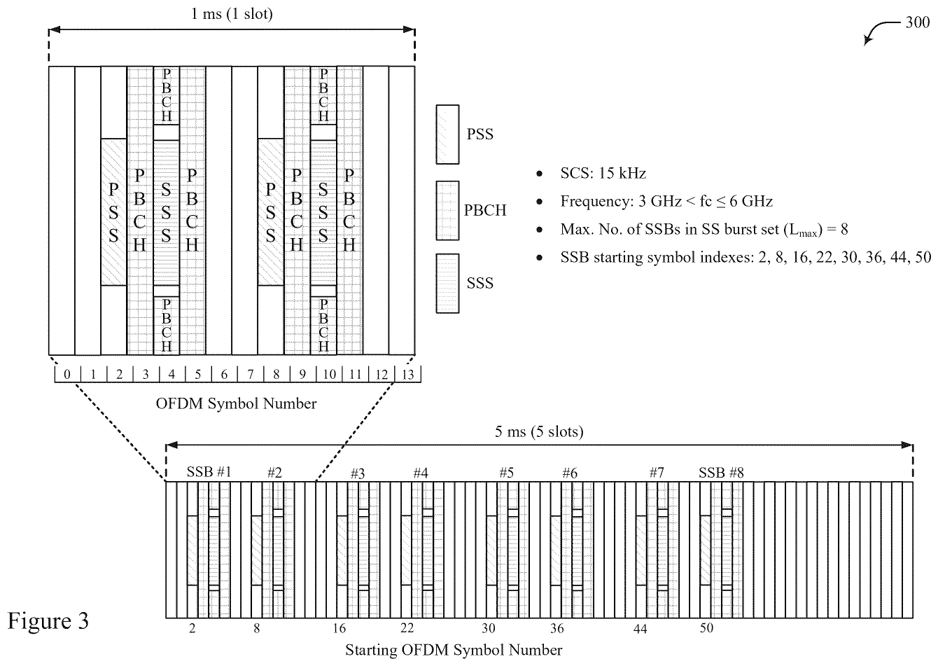

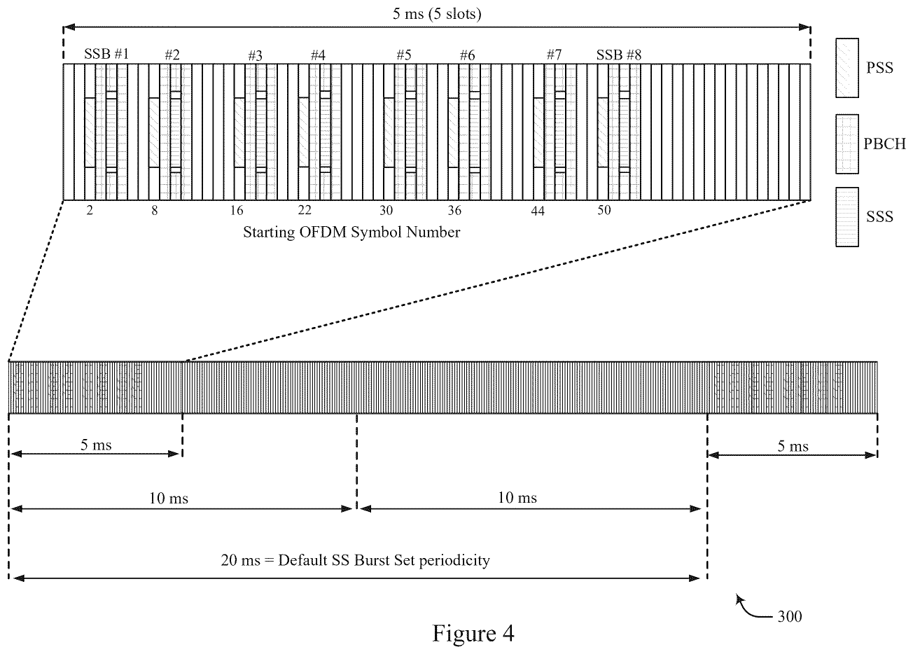

FIGS. 3 and 4 illustrate an example 300 for the timing of candidate SS/PBCH blocks within the SS burst set. The example 300, for instance, is for the case of SCS=15 kHz and carrier frequency between 3 GHz and 6 GHz.

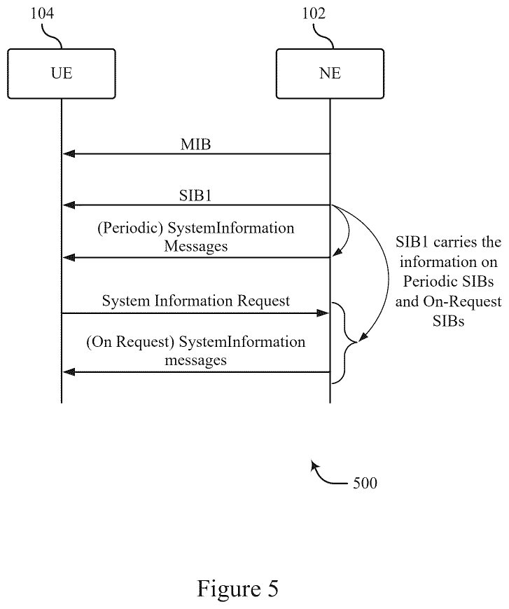

FIG. 5 illustrates an example procedure 500 for MIB and SIB transmission and relationships among SIBs. The procedure 500, for instance, illustrates communication between a NE 102 and a UE 104.

The following represents some characteristics of MIB. See 3GPP TS 38.331-5.2.1 and TS 38.213-4.1 for further details of MIB scheduling. MIB can be transmitted over broadcast channel (BCH)/PBCH. PBCH is transmitted as a part of SSB. MIB can be transmitted with the periodicity of 80 ms and within this 80 ms repetitive transmission can occur. For initial cell selection, a UE may assume that half frames with SS/PBCH blocks occur with a periodicity of 2 frames. MIB can include the parameters that are required to decode SIB1.

The following represents an example implementation of an MIB:

MIB ::= SEQUENCE {

| | |
|---|---|
| systemFrameNumber | BIT STRING (SIZE (6)), |
| subCarrierSpacingCommon | ENUMERATED {scs15or60, |
| | scs30or120}, |
| ssb-SubcarrierOffset | INTEGER (0..15), |
| dmrs-TypeA-Position | ENUMERATED {pos2, pos3}, |
| pdcch-ConfigSIB1 | INTEGER (0..255), |
| cellBarred | ENUMERATED {barred, notBarred}, |
| intraFreqReselection | ENUMERATED {allowed, notAllowed}, |
| spare | BIT STRING (SIZE (1)) |

}

The field subCarrierSpacingCommon indicates the Subcarrier spacing for SIB1, Msg.2/4 for initial access and system information (SI)-messages. Interpretation of this value varies with frequency range as summarized in Table 4.

TABLE 4

| | scs15or60 | scs30or120 |
|---|---|---|
| FR1 | 15 Khz | 30 Khz |
| FR2 | 60 Khz | 120 Khz |

The field ssb-subcarrierOffset corresponds to k_{ssb} (see, e.g., 3GPP TS 38.213). This field indicates the frequency domain offset between SSB and the overall resource block grid in number of subcarriers. If k_ssb requires the value higher than 15, it is represented by the combination of a PBCH data field and ssb-subcarrierOffset. The field dmrs-TypeA-Position indicates position of (first) downlink (DL) DM-RS. The field pdcchConfigSIB1 determines a bandwidth for physical downlink control channel (PDCCH)/SIB, a common ControlResourceSet (CORESET), a common search space, and necessary PDCCH parameters. This corresponds to remaining minimum system information (RMSI)-PDCCH-Config.

The following represent characteristics of SIB1 such as in 5G implementations. SIB1 can be transmitted over downlink shared channel (DL-SCH) (NOTE: SIB1 is the first RRC message except MIB). The UE is expected to be able to decode SIB1 without much information from over-the air (OTA) signaling message. Therefore, 3GPP defines specific procedures to transmit and/or decode DCI and physical downlink shared channel (PDSCH) for SIB1. SIB1 can be transmitted with the periodicity of 160 ms and within this 160 ms repetitive transmission can occur. SIB1 includes information regarding the availability and scheduling (e.g. periodicity, SI-window size) of other SIB. SIB1 indicates whether other SIBs are provided via periodic broadcast basis or only on-demand basis. If other SIBs than SIB1 are provided on-demand the SIB1 can include information for the UE to perform SI request.

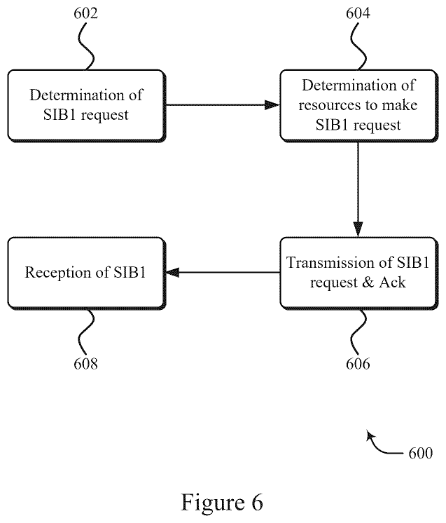

FIG. 6 illustrates an example 600 of a 4-step procedure for acquiring on-demand SIB1. When the UE 104 is trying to select or reselect a cell, the UE 104 selects a target cell from multiple candidate cells (which may also be referred to as neighboring cells). A candidate cell refers to a cell that is eligible to be a next serving cell for the UE 104 (e.g., is within range of the UE 104, has greater than a threshold signal power and/or quantity (e.g., RSRP and/or RSRQ) measurements, etc.). The UE 104 performs target cell ranking based on measurement of intra-frequency cells or same priority inter-frequency cells to select, for example, a highest ranking cell to be the target cell. The UE 104 determines at 602 whether the UE 104 is to make a SIB1 request for the target cell. At 604, the UE 104 determines how to obtain resources to make the SIB1 request for the target cell, also referred to as obtaining a SIB1 request configuration for the target cell. At 606 the UE 104 makes the SIB1 request for the target cell based on the obtained SIB1 request configuration for the target cell, also referred to as starting the SIB1 request (e.g., communicating, transmitting, or sending the SIB1 request to the target cell or its current serving cell). At 608 the UE 104 receives the SIB1 for the target cell.

The techniques discussed herein handle some error scenarios at 602 and/or 604, e.g., if the UE 104 cannot immediately determine if the cell in question provides SIB1 on an on-demand basis (or that it does not provide SIB1 at all). Similarly, some techniques discussed herein describe UE behavior if the UE 104 cannot obtain or determine a SIB1 request configuration.

In one or more implementations, three different types of cells are defined: an NES Cell, a Cell A (also referred to as an Anchor Cell), and a Cell X. An NES Cell refers to a network cell that intends to save energy by not transmitting (e.g., not communicating, not sending, not outputting) SIB1 regularly. A Cell A refers to a network cell that provides a configuration to request SIB1 of an NES Cell (e.g., provides a SIB1 request configuration for an NES Cell). The Cell A can be, but need not be, an NES Cell. A Cell X refers to a network cell that is neither an NES Cell nor a Cell A (e.g., a release 18 or earlier network cell).

A UE 104 may be camping on Cell X or Cell A in different scenarios or situations. A UE starts measurements, generally for a plurality of cells, when one of the following happens. If the serving cell quality goes below a certain threshold, then the UE 104 performs cell ranking based on measurement of intra-frequency cells or same priority inter-frequency cells. In this case, the cell ranking is performed based on the Idle mode measurement configuration present in SIB2, 3 and 4 available from the serving cell's broadcast channel. The UE 104 tries to then reselect to the highest ranked cell. Additionally or alternatively, the UE starts measuring cells at higher (than current serving frequency) priority carrier frequency or frequencies—this is done periodically according to performance requirements described in 3GPP TS 38.133.

In both cases, after initial measurements (e.g., RSRP/RSRQ measurements on SSB) it is possible that the highest ranked cell (or the best candidate in a higher (than current serving frequency) priority frequency) is an NES Cell. This highest ranked cell (or the best candidate in a higher priority frequency) is also referred to as the target cell.

In one or more implementations, the UE 104 can determine that the target cell is an NES Cell, and the target cell does not broadcast (e.g., transmit, send, output) SIB1 regularly, e.g., the target cell provides SIB1 (dedicatedly or broadcasted) only on an on-demand basis. This determination can be performed in various manners. For example, availability of SIB1 on-demand request can be determined in different ways such as via use of custom PCIs, failure to receive SIB1 after a threshold timer and/or threshold number of SIB1 acquisition attempts, cell barring (e.g., in MIB), subcarrier offset indicating that SIB1 is not broadcasted (e.g., is to be requested on-demand), and/or a value determined from SSB and/or MIB. Based on a determination of whether on-demand SIB transmission is available, the UE 104 can determine whether to attempt to detect broadcasted SIB1 and/or to request on-demand SIB1 transmission.

In order to obtain SIB1 from such a cell, the UE 104 uses a SIB1 request configuration (also referred to as a wake-up signal (WUS) configuration), which indicates SIB1 request resources (resources used to request a SIB1). The UE 104 can receive the SIB1 request resources from an anchor cell (such as a type Cell A), which might be a current serving cell in one example, where the UE 104 is doing a reselection evaluation, or from the NES cell itself in a different example (e.g., by re-purposing MIB fields). SIB1 request resources (e.g., PRACH resources, time/frequency resources, etc.) for requesting on-demand SIB1 transmission can be determined in various ways. For instance, the UE 104 can determine request resources as a function of resources on which SSB transmission is received. Request resources, for example, can be determined as combinations of MIB and/or PBCH bits to determine a frequency offset for determining resources for a PRACH transmission requesting SIB1. Alternatively or additionally, a PRACH occasion for requesting SIB1 can be determined as a function of PCI and/or of MIB or PBCH content. Thus, implementations can enable a NE to refrain from broadcasting SIB1 (e.g., periodically) and respond to on-demand requests for SIB1 transmission using targeted SIB1 transmission.

The techniques discussed herein address how long the SIB1 request configuration is considered valid once acquired (e.g., received, obtained) by the UE 104. In one or more implementations, the SIB1 request configuration includes a validity time indicating how long after the acquisition of the SIB1 request configuration the SIB1 request configuration is still considered valid for the UE 104 to issue a SIB1 request. When or after the validity timer expires, prior to issuing a SIB1 request the UE 104 acquires (e.g., receives, obtains) the SIB1 request configuration again, if and when needed. Additionally or alternatively, the validity timer is not signaled in the SIB1 request configuration but rather is specified. Additionally or alternatively, a value Tag is used which can be associated to an RRC signaling (e.g., SIB) of Cell A providing the SIB1 request configuration for a given Anchor Cell. In this case, the UE 104 ensures that it has the SIB1 request configuration corresponding to the latest value Tag of the RRC signaling (e.g., SIB), which may be broadcasted in the SIB1 of the Cell A. If the SIB includes SIB1 request configuration for multiple cells, e.g., up to ‘N’ cells, a BITMAP of length ‘N*m’ can be included in SIB1, where ‘m’ is the number of bits used for each value Tag and indicates the granularity of value Tag(s).

If after repeated attempts, the UE 104 fails to acquire (e.g., receive, obtain) SIB1 of the NES Cell, e.g., after performing a threshold (e.g., maximum) number of acquisition attempts (from the broadcast channel and/or after a threshold (e.g., maximum) number of RACH Msg1 transmissions without receiving a positive response in Msg2), the UE 104 bars the cell for an amount of time (e.g., a predetermined time up to 300 seconds). A cell being barred refers to the cell being ignored or not eligible to be a serving cell for the UE 104 until the cell is no longer barred (e.g., is unbarred), after which the cell can be considered as a possible target cell in future cell selection or reselection evaluation. In such a case whether the UE 104 is allowed to select or reselect another cell on the same frequency (e.g., the frequency of the NES cell) can be decided based on the intraFreqReselection parameter broadcasted in MIB and/or SIB1 for a corresponding feature UE ((e-) Reduced Capability (RedCap), 2 2 receiver (Rx)XR).

In some situations the UE 104 may fail to acquire the SIB1 request configuration for the NES Cell. Here “failing” refers to, for example, that from the moment the UE 104 becomes aware of the need to request SIB1 of an NES cell, the UE 104 has not been able to acquire the SIB1 request configuration for the NES Cell for a time longer than a certain threshold (which may be a value configurable by the network, specified, or left for UE implementation), or made a threshold number of attempts. As another example of “failing,” the UE 104 is camped on Cell X described previously. As another possibility, the current serving cell provides SIB1 request configuration of at least one cell but the target cell (e.g., a best radio candidate cell) is not included in the received SIB1 request configuration. In such a case the UE 104 does one of the following. The UE 104 does not consider the NES Cell as barred and proceeds with the cell reselection procedure as if the NES cell was no longer the best ranking cell, e.g., the UE 104 ignores the NES cell until the SIB1 request configuration is available and/or the SIB1 of the NES cell is acquired. This results in the UE 104 not considering the NES Cell as barred and proceeding with the cell reselection procedure for inter-frequency candidates; for intra-frequency and same priority inter-frequency candidates, the intraFreqReselection parameter broadcasted in MIB and/or SIB1 can be used. Consequently, the UE 104 does not consider the NES Cell as barred. Additionally or alternatively, the UE 104 bars the NES cell for an amount of time (e.g., a predetermined time up to 300 seconds). The UE 104 may exclude the barred cell as a candidate for cell selection and/or reselection for up to 300 seconds in accordance with 3GPP TS 38.304.

In one or more implementations, the UE 104 determines that the target cell (e.g., an NES Cell) does not provide (e.g., communicate, transmit, output) SIB1 regularly, e.g., from MIB (the field ssb-SubcarrierOffset indicates that SIB1 is absent) but cannot determine (e.g., is unaware of) whether the highest ranked cell is an NES Cell that provides SIB1 on an on-demand basis, e.g., does not regularly broadcast SIB1. In one example, in such situations the UE 104 bars the NES cell until the UE 104 realizes that the NES cell provides SIB1 on an on-demand basis, e.g., when the UE 104 finds a Cell A providing SIB1 request configuration for the NES Cell. If the UE 104 used a barring timer (e.g., up to 300 seconds), the timer is stopped on occurrence of one of the following events: the UE 104 receives a SIB1 request configuration for the NES Cell, or the UE 104 acquires SIB1 of the NES Cell.

In one or more implementations, the UE 104 determines that it cannot acquire SIB1 for the target cell (e.g., an NES Cell) for some time. In one example, the UE 104 considers the target cell as barred unless or until one or more of the SIB1 request configuration or the SIB1 is available for the target cell. According to another example, the UE 104 considers the target cell as non-barred for up to a predetermined duration after ranking the target cell, after which the UE 104 considers the target cell as barred unless it receives one or more of a SIB1 request configuration or the SIB1 for the target cell. If the UE 104 maintains a barring timer for the cell, e.g. running up to 300 seconds, the timer is stopped on occurrence of one of the following events: the UE 104 receives a SIB1 request configuration for the target Cell, or the UE 104 acquires the SIB1 of the Cell.

In any of the implementations discussed above, the UE 104 may trigger a new measurement and/or cell re-selection procedure when the UE 104 obtains (e.g., receives) the SIB1 or SIB1 request configuration for a cell that is considered barred (or was considered barred until this point, e.g., barring can be lifted if the UE 104 obtains SIB1 or SIB1 request configuration for a barred cell).

In one or more implementations, a network cell (Cell A) indicates one or more of the following: a list of one or more neighboring NES cells for which the SIB1 request configuration is provided, a list of one or more neighboring NES cells for which the SIB1 request can be received, a list of one or more neighboring NES cells for which the SIB1 request is expected and SIB1 is provided.

The list of neighbor cells can be a positive list, e.g., listing only neighboring cells for which the SIB1 request configuration is provided (e.g., transmitted, output) and/or SIB1 request can be received (e.g., obtained) and/or SIB1 is provided (e.g., transmitted, output). For any cell not included in the list, the SIB1 request configuration is not provided nor can SIB1 request be received. In one example, the positive list is created based on neighbor list information already included in SIB3 and SIB4. For each cell included in the SIB3 and/or SIB4, information (e.g., SIB1 request configuration) is included only for ‘positive’ cells and not included for remaining cells. Additionally or alternatively, the SIB1 request configuration (e.g., PRACH resources) are provided as common resources for ‘positive’ cells and a Boolean indication is used in the SIB3 intra-frequency neighbor cell list and/or SIB4 inter-frequency neighbor cell list to indicate for which one or more cells the PRACH resources for SIB1 request apply.

The list of neighbor cells can be a negative list, e.g., listing only neighboring cells for which the SIB1 request configuration is not provided (e.g., not transmitted, not output) nor can SIB1 request be received (e.g., obtained). For any other cell not included in the list, the SIB1 request configuration is provided and SIB1 request can be received and/or SIB1 is provided. Similar to the positive case, here in one example, the negative list is created based on neighbor list information already included in SIB3 and SIB4. For each cell included in the SIB3 and/or SIB4, information (e.g., SIB1 request configuration) is not included only for ‘negative’ cells and included for remaining cells. Additionally or alternatively, the SIB1 request Configuration (e.g., PRACH resources) are provided as common resources for ‘positive’ cells and a Boolean indication is used in the SIB3 intra-frequency neighbor cell list and/or SIB4 inter-frequency neighbor cell list to indicate for which one or more cells the PRACH resources for SIB1 request do not apply.

In one or more implementations, upon determining a target cell that is the best radio candidate (the best ranking cell for intra and same-priority inter-frequency, or the best radio cell of a higher (than serving) priority frequency), the UE 104 checks if its serving cell is providing the above indication(s). Only when the serving cell is providing the above indication(s) the UE 104 initiates requesting SIB1 for the target cell. The UE 104 requests SIB1 for an NES Cell only to its serving cell when the serving cell provides the SIB1 request Configuration and/or is ready to receive the SIB1 request for the NES cell, based on the mentioned indication.

Accordingly, validity of SIB1 Request configuration is discussed. The configuration can include a validity time, a validity timer can be specified, and/or a value Tag can be used.

Also discussed is if a UE fails to acquire SIB1 of the NES Cell, the UE bars the cell for up to 300 seconds: intra-frequency reselection can be decided based on the intraFreqReselection parameter broadcasted in MIB and/or SIB1.

Also discussed is if a UE fails to acquire the SIB1 Request configuration for the NES Cell since the UE has not been able to acquire the SIB1 Request configuration for the NES Cell for a time longer than a certain threshold, the current serving cell provides SIB1 request configuration of at least one cell but the intended target cell (e.g., a best radio candidate cell) is not included in the received SIB1 request configuration, and/or the UE is camped on Cell X. As a solution, the UE does not consider the NES Cell as barred and proceeds with the cell reselection procedure as if the NES cell was no more the best ranking cell; the intraFreqReselection parameter broadcasted in MIB and/or SIB1 can be used. Additionally or alternatively, the UE bars the NES cell for up to 300 seconds.

Also discussed is if a UE determines that the highest ranked cell (NES Cell) does not provide SIB1 regularly but cannot determine that the highest ranked cell is an NES Cell that provides SIB1 only on an on-demand basis. In this case: the UE bars the NES Cell until the UE realizes that the NES Cell provides SIB1 on on-demand basis, e.g., when the UE finds a Cell A providing SIB1 request configuration for the NES Cell. If the UE used a up to 300 seconds barring timer, the timer should be stopped on occurrence of one of the following events: the UE receives SIB1 request configuration for the NES Cell, or the UE acquires SIB1 of the NES Cell. Thus, rather than keeping a best radio cell barred unnecessarily for a long time (e.g., 300 seconds), the techniques discussed herein realize a scenario where the UE receives the SIB1 request configuration and/or receives the SIB1 itself earlier than the 300 seconds, and ceases barring the cell unnecessarily for the remainder of the timer (e.g., 300 seconds).

Also discussed is a UE may trigger a new measurement and/or cell re-selection procedure when the UE obtains SIB1 or SIB1 request configuration for a cell that is considered barred.

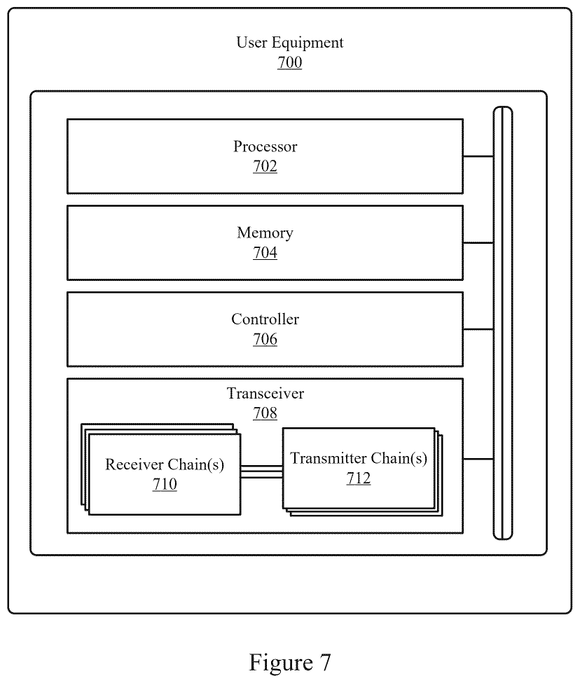

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for, while operating in a RRC idle mode, selecting from multiple candidate cells, a target cell to be a next serving cell for the UE; starting, based on the target cell providing SIB1 on an on-demand basis and in response to receiving a SIB1 request configuration for the target cell, a SIB1 request for the target cell based at least in part on the SIB1 request configuration for the target cell; and reselecting, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation.

Additionally, the UE 700 may be configured to support any one or combination of where reselecting the secondary candidate cell comprises reselecting the secondary candidate cell on a same frequency as the target cell in response to intra-frequency reselection being allowed; where the SIB1 request configuration for the target cell includes a validity time or validity tag indicating how long the SIB1 request configuration is valid; where reselecting the secondary candidate cell comprises reselecting the secondary candidate cell on another frequency than the target cell in response to intra-frequency reselection not being allowed; where the UE fails to receive the SIB1 request configuration for the target cell due to at least one of not being able to acquire the SIB1 request configuration within a threshold amount of time, a current serving cell of the UE being neither an NES cell nor an anchor cell, or receiving SIB1 request configurations for one or more cells of the multiple candidate cells other than the target cell; further including, in response to not receiving the SIB1 request configuration for the target cell, ignoring the target cell until the SIB1 request configuration for the target cell is received or the SIB1 of the target cell is acquired; further including, in response to not receiving the SIB1 request configuration for the target cell, barring the target cell for future cell selection or reselection for a threshold amount of time; where the UE is unaware that the target cell provides the SIB1 on an on-demand basis, and further including ignoring the target cell until the SIB1 request configuration for the target cell is received or the SIB1 of the target cell is acquired; where the target cell comprises one of the multiple candidate cells having a highest ranking or a one of the multiple target cells in a higher priority frequency than a frequency of a current serving cell for the UE.

Additionally, or alternatively, the UE 700 may support at least one memory (e.g., the memory 704) and at least one processor (e.g., the processor 702) coupled with the at least one memory and configured to cause the UE, operating in a RRC idle mode, to: select from multiple candidate cells, a target cell to be a next serving cell for the UE; start, based on the target cell providing SIB1 on an on-demand basis and in response to receiving a SIB1 request configuration for the target cell, a SIB1 request for the target cell based at least in part on the SIB1 request configuration for the target cell; reselect, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation.

Additionally, the UE 700 may be configured to support any one or combination of the at least one processor is configured to where the SIB1 request configuration for the target cell includes a validity time or validity tag indicating how long the SIB1 request configuration is valid; where to reselect the secondary candidate cell is to reselect the secondary candidate cell on a same frequency as the target cell in response to intra-frequency reselection being allowed; where to reselect the secondary candidate cell is to reselect the secondary candidate cell on another frequency than the target cell in response to intra-frequency reselection not being allowed; where the UE fails to receive the SIB1 request configuration for the target cell due to at least one of not being able to acquire the SIB1 request configuration within a threshold amount of time, a current serving cell of the UE being neither an NES cell nor an anchor cell, or receiving SIB1 request configurations for one or more cells of the multiple candidate cells other than the target cell; where the at least one processor is further configured to cause the UE to, in response to not receiving the SIB1 request configuration for the target cell, ignore the target cell until the SIB1 request configuration for the target cell is received or the SIB1 of the target cell is acquired; where the at least one processor is further configured to cause the UE to, in response to not receiving the SIB1 request configuration for the target cell, bar the target cell for future cell selection or reselection for a threshold amount of time; where the UE is unaware that the target cell provides the SIB1 on an on-demand basis, and the at least one processor is further configured to cause the UE to ignore the target cell until the SIB1 request configuration for the target cell is received or the SIB1 of the target cell is acquired; where the target cell comprises one of the multiple candidate cells having a highest ranking or a one of the multiple target cells in a higher priority frequency than a frequency of a current serving cell for the UE.

As another example, the processor 702 may support wireless communication at the UE 700 in accordance with examples as disclosed herein. The UE 700 may be configured to or operable to support a means for, operating in a RRC idle mode, selecting from multiple candidate cells, a target cell to be a next serving cell for the UE; receiving, from a base station of a current serving cell for the UE, a list of one or more neighboring NES cells; receiving, from the base station, a SIB1 request configuration for the target cell; starting, based at least in part on the list of one or more NES cells, a SIB1 request for the target cell based at least in part on the SIB1 request configuration for the target cell.

Additionally, the UE 700 may be configured to support any one or combination of where the list of one or more neighboring NES cells comprises neighboring NES cells for which the base station can provide the SIB1 request configuration; where the list of one or more neighboring NES cells comprises neighboring NES cells for which the base station can receive the SIB1 request; where the list of one or more neighboring NES cells comprises neighboring NES cells for which the base station expects the SIB1 request and can provide the SIB1; where the list of one or more neighboring NES cells comprises neighboring NES cells for which the base station can provide the SIB1 request configuration, can receive the SIB1 request, can provide the SIB1, or a combination thereof; where the list of one or more neighboring NES cells comprises neighboring NES cells for which the base station cannot provide the SIB1 request configuration, cannot receive the SIB1 request, or a combination thereof.

Additionally, or alternatively, the UE 700 may support at least one memory (e.g., the memory 704) and at least one processor (e.g., the processor 702) coupled with the at least one memory and configured to cause the UE, operating in a RRC idle mode, to: select from multiple candidate cells, a target cell to be a next serving cell for the UE; receive, from a base station of a current serving cell for the UE, a list of one or more neighboring NES cells; receive, from the base station, a SIB1 request configuration for the target cell; start, based at least in part on the list of one or more NES cells, a SIB1 request for the target cell based at least in part on the SIB1 request configuration for the target cell.

Additionally, the UE 700 may be configured to support any one or combination of where the list of one or more neighboring NES cells comprises neighboring NES cells for which the base station can provide the SIB1 request configuration; where the list of one or more neighboring NES cells comprises neighboring NES cells for which the base station can receive the SIB1 request; where the list of one or more neighboring NES cells comprises neighboring NES cells for which the base station expects the SIB1 request and can provide the SIB1; where the list of one or more neighboring NES cells comprises neighboring NES cells for which the base station can provide the SIB1 request configuration, can receive the SIB1 request, can provide the SIB1, or a combination thereof; where the list of one or more neighboring NES cells comprises neighboring NES cells for which the base station cannot provide the SIB1 request configuration, cannot receive the SIB1 request, or a combination thereof.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

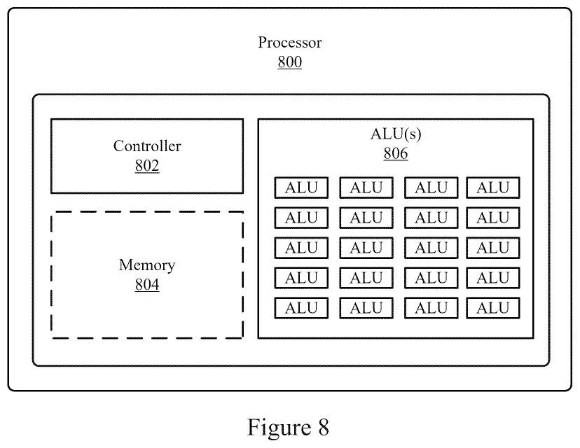

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor, operating in a RRC idle mode, to: select from multiple candidate cells, a target cell to be a next serving cell for the processor; start, based on the target cell providing SIB1 on an on-demand basis and in response to receiving a SIB1 request configuration for the target cell, a SIB1 request for the target cell based at least in part on the SIB1 request configuration for the target cell; reselect, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation.

Additionally, the processor 800 may be configured to or operable to support any one or combination of the at least one controller is configured to cause the processor to where the SIB1 request configuration for the target cell includes a validity time or validity tag indicating how long the SIB1 request configuration is valid; where to reselect the secondary candidate cell is to reselect the secondary candidate cell on a same frequency as the target cell in response to intra-frequency reselection being allowed; where to reselect the secondary candidate cell is to reselect the secondary candidate cell on another frequency than the target cell in response to intra-frequency reselection not being allowed; where the processor fails to receive the SIB1 request configuration for the target cell due to at least one of not being able to acquire the SIB1 request configuration within a threshold amount of time, a current serving cell of the processor being neither an NES cell nor an anchor cell, or receiving SIB1 request configurations for one or more cells of the multiple candidate cells other than the target cell; where the at least one controller is further configured to cause the processor to, in response to not receiving the SIB1 request configuration for the target cell, ignore the target cell until the SIB1 request configuration for the target cell is received or the SIB1 of the target cell is acquired; where the at least one controller is further configured to cause the processor to, in response to not receiving the SIB1 request configuration for the target cell, bar the target cell for future cell selection or reselection for a threshold amount of time; where the processor is unaware that the target cell provides the SIB1 on an on-demand basis, and the at least one controller is further configured to cause the processor to ignore the target cell until the SIB1 request configuration for the target cell is received or the SIB1 of the target cell is acquired; where the target cell comprises one of the multiple candidate cells having a highest ranking or a one of the multiple target cells in a higher priority frequency than a frequency of a current serving cell for the processor.

The processor 800 may be configured to or operable to support at least one controller (e.g., the controller 802) coupled with at least one memory (e.g., the memory 804) and configured to cause the processor, operating in a RRC idle mode, to: select from multiple candidate cells, a target cell to be a next serving cell for the processor; receive, from a base station of a current serving cell for the processor, a list of one or more neighboring NES cells; receive, from the base station, a SIB1 request configuration for the target cell; start, based at least in part on the list of one or more NES cells, a SIB1 request for the target cell based at least in part on the SIB1 request configuration for the target cell.

Additionally, the processor 800 may be configured to or operable to support any one or combination of where the list of one or more neighboring NES cells comprises neighboring NES cells for which the base station can provide the SIB1 request configuration; where the list of one or more neighboring NES cells comprises neighboring NES cells for which the base station can receive the SIB1 request; where the list of one or more neighboring NES cells comprises neighboring NES cells for which the base station expects the SIB1 request and can provide the SIB1; where the list of one or more neighboring NES cells comprises neighboring NES cells for which the base station can provide the SIB1 request configuration, can receive the SIB1 request, can provide the SIB1, or a combination thereof; where the list of one or more neighboring NES cells comprises neighboring NES cells for which the base station cannot provide the SIB1 request configuration, cannot receive the SIB1 request, or a combination thereof.

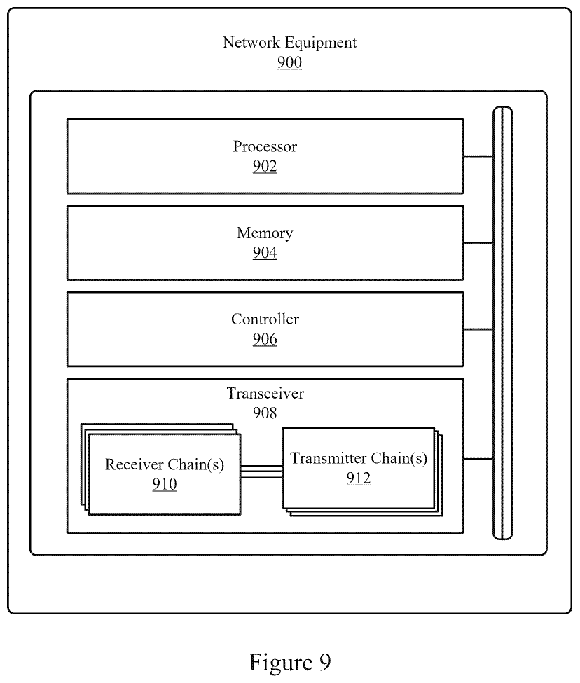

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to support a means for communicating, to a UE, a list of one or more neighboring NES cells; communicating, to the UE, a SIB1 request configuration for a target cell that is a neighboring NES cell; receiving, from the UE, a SIB1 request for the target cell; communicating, to the UE in response to the SIB1 request, the SIB1 for the target cell.

Additionally, the NE 900 may be configured to support any one or combination of where the list of one or more neighboring NES cells comprises neighboring NES cells for which the base station can provide the SIB1 request configuration; where the list of one or more neighboring NES cells comprises neighboring NES cells for which the base station can receive the SIB1 request; where the list of one or more neighboring NES cells comprises neighboring NES cells for which the base station expects the SIB1 request and can provide the SIB1; where the list of one or more neighboring NES cells comprises neighboring NES cells for which the base station can provide the SIB1 request configuration, can receive the SIB1 request, can provide the SIB1, or a combination thereof; where the list of one or more neighboring NES cells comprises neighboring NES cells for which the base station cannot provide the SIB1 request configuration, cannot receive the SIB1 request, or a combination thereof.

Additionally, or alternatively, the NE 900 may support at least one memory (e.g., the memory 904) and at least one processor (e.g., the processor 902) coupled with the at least one memory and configured to cause the NE to: communicate, to a UE, a list of one or more neighboring NES cells; communicate, to the UE, a SIB1 request configuration for a target cell that is a neighboring NES cell; receive, from the UE, a SIB1 request for the target cell; communicate, to the UE in response to the SIB1 request, the SIB1 for the target cell.

Additionally, the NE 900 may be configured to support any one or combination of where the list of one or more neighboring NES cells comprises neighboring NES cells for which the base station can provide the SIB1 request configuration; where the list of one or more neighboring NES cells comprises neighboring NES cells for which the base station can receive the SIB1 request; where the list of one or more neighboring NES cells comprises neighboring NES cells for which the base station expects the SIB1 request and can provide the SIB1; where the list of one or more neighboring NES cells comprises neighboring NES cells for which the base station can provide the SIB1 request configuration, can receive the SIB1 request, can provide the SIB1, or a combination thereof; where the list of one or more neighboring NES cells comprises neighboring NES cells for which the base station cannot provide the SIB1 request configuration, cannot receive the SIB1 request, or a combination thereof.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

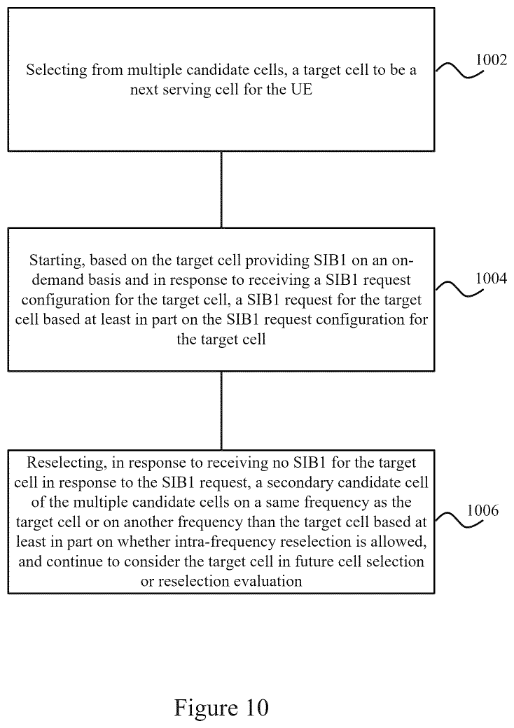

FIG. 10 illustrates a flowchart of a method in accordance with aspects of the present disclosure. The operations of the method may be implemented by a UE as described herein. In some implementations, the UE may execute a set of instructions to control the function elements of the UE to perform the described functions.

At 1002, the method may include selecting from multiple candidate cells, a target cell to be a next serving cell for the UE. The operations of 1002 may be performed in accordance with examples as described herein. In some implementations, aspects of the operations of 1002 may be performed by a UE as described with reference to FIG. 7.

At 1004, the method may include starting, based on the target cell providing SIB1 on an on-demand basis and in response to receiving a SIB1 request configuration for the target cell, a SIB1 request for the target cell based at least in part on the SIB1 request configuration for the target cell. The operations of 1004 may be performed in accordance with examples as described herein. In some implementations, aspects of the operations of 1004 may be performed by a UE as described with reference to FIG. 7.

At 1006, the method may include reselecting, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation. The operations of 1006 may be performed in accordance with examples as described herein. In some implementations, aspects of the operations of 1006 may be performed a UE as described with reference to FIG. 7.

It should be noted that the method described herein describes a possible implementation, and that the operations and the steps may be rearranged or otherwise modified and that other implementations are possible.

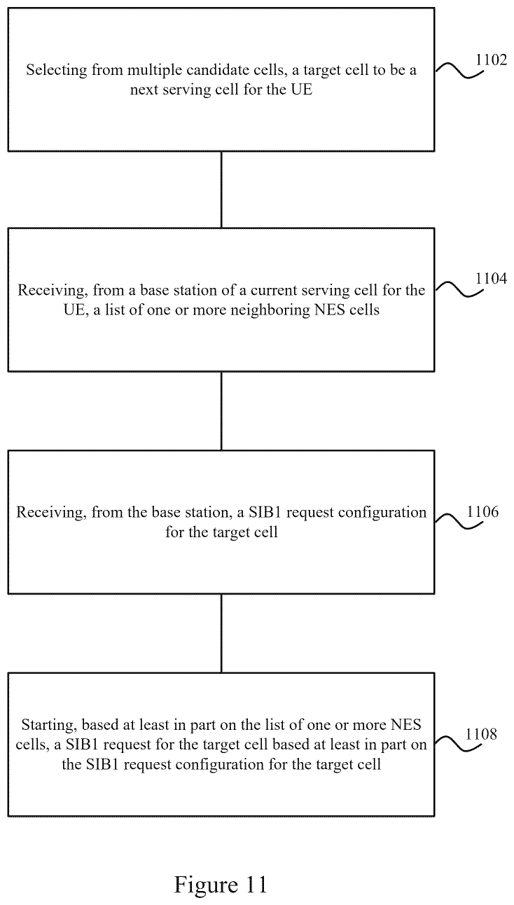

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include selecting from multiple candidate cells, a target cell to be a next serving cell for the UE. The operations of 1102 may be performed in accordance with examples as described herein. In some implementations, aspects of the operations of 1102 may be performed by a UE as described with reference to FIG. 7.

At 1104, the method may include receiving, from a base station of a current serving cell for the UE, a list of one or more neighboring NES cells. The operations of 1104 may be performed in accordance with examples as described herein. In some implementations, aspects of the operations of 1104 may be performed by a UE as described with reference to FIG. 7.

At 1106, the method may include receiving, from the base station, a SIB1 request configuration for the target cell. The operations of 1106 may be performed in accordance with examples as described herein. In some implementations, aspects of the operations of 1106 may be performed a UE as described with reference to FIG. 7.

At 1108, the method may include starting, based at least in part on the list of one or more NES cells, a SIB1 request for the target cell based at least in part on the SIB1 request configuration for the target cell. The operations of 1108 may be performed in accordance with examples as described herein. In some implementations, aspects of the operations of 1108 may be performed a UE as described with reference to FIG. 7.

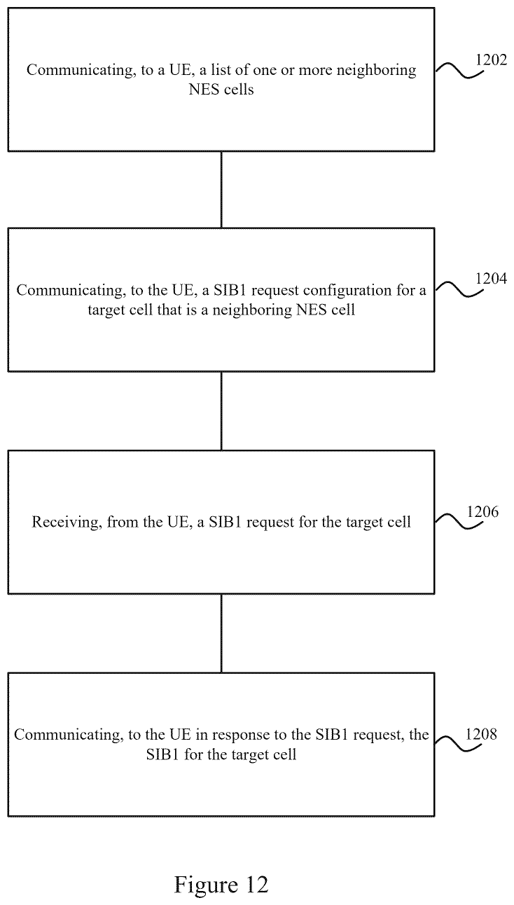

FIG. 12 illustrates a flowchart of a method in accordance with aspects of the present disclosure. The operations of the method may be implemented by a NE as described herein. In some implementations, the NE may execute a set of instructions to control the function elements of the NE to perform the described functions.

At 1202, the method may include communicating, to a UE, a list of one or more neighboring NES cells. The operations of 1202 may be performed in accordance with examples as described herein. In some implementations, aspects of the operations of 1202 may be performed by a NE as described with reference to FIG. 9.

At 1204, the method may include communicating, to the UE, a SIB1 request configuration for a target cell that is a neighboring NES cell. The operations of 1204 may be performed in accordance with examples as described herein. In some implementations, aspects of the operations of 1204 may be performed by a NE as described with reference to FIG. 9.

At 1206, the method may include receiving, from the UE, a SIB1 request for the target cell. The operations of 1206 may be performed in accordance with examples as described herein. In some implementations, aspects of the operations of 1206 may be performed a NE as described with reference to FIG. 9.

At 1208, the method may include communicating, to the UE in response to the SIB1 request, the SIB1 for the target cell. The operations of 1208 may be performed in accordance with examples as described herein. In some implementations, aspects of the operations of 1208 may be performed a NE as described with reference to FIG. 9.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE, operating in a radio resource control (RRC) idle mode, to:
select from multiple candidate cells, a target cell to be a next serving cell for the UE;
start, based on the target cell providing system information block 1 (SIB1) on an on-demand basis and in response to receiving a SIB1 request configuration for the target cell, a SIB1 request for the target cell based at least in part on the SIB1 request configuration for the target cell;
reselect, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation.

2. The UE of claim 1, wherein the SIB1 request configuration for the target cell includes a validity time or validity tag indicating how long the SIB1 request configuration is valid.

3. The UE of claim 1, wherein to reselect the secondary candidate cell is to reselect the secondary candidate cell on a same frequency as the target cell in response to intra-frequency reselection being allowed.

4. The UE of claim 1, wherein to reselect the secondary candidate cell is to reselect the secondary candidate cell on another frequency than the target cell in response to intra-frequency reselection not being allowed.

5. The UE of claim 1, wherein the UE fails to receive the SIB1 request configuration for the target cell due to at least one of not being able to acquire the SIB1 request configuration within a threshold amount of time, a current serving cell of the UE being neither a network energy saving (NES) cell nor an anchor cell, or receiving SIB1 request configurations for one or more cells of the multiple candidate cells other than the target cell.

6. The UE of claim 5, wherein the at least one processor is further configured to cause the UE to, in response to not receiving the SIB1 request configuration for the target cell, ignore the target cell until the SIB1 request configuration for the target cell is received or the SIB1 of the target cell is acquired.

7. The UE of claim 5, wherein the at least one processor is further configured to cause the UE to, in response to not receiving the SIB1 request configuration for the target cell, bar the target cell for future cell selection or reselection for a threshold amount of time.

8. The UE of claim 1, wherein the UE is unaware that the target cell provides the SIB1 on an on-demand basis, and the at least one processor is further configured to cause the UE to ignore the target cell until the SIB1 request configuration for the target cell is received or the SIB1 of the target cell is acquired.

9. The UE of claim 1, wherein the target cell comprises one of the multiple candidate cells having a highest ranking or a one of the multiple target cells in a higher priority frequency than a frequency of a current serving cell for the UE.

10. A processor for wireless communication, comprising:
at least one controller coupled with at least one memory and configured to cause the processor, operating in a radio resource control (RRC) idle mode, to:
select from multiple candidate cells, a target cell to be a next serving cell for the processor;
start, based on the target cell providing system information block 1 (SIB1) on an on-demand basis and in response to receiving a SIB1 request configuration for the target cell, a SIB1 request for the target cell based at least in part on the SIB1 request configuration for the target cell;
reselect, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation.

11. The processor of claim 10, wherein the SIB1 request configuration for the target cell includes a validity time or validity tag indicating how long the SIB1 request configuration is valid.

12. The processor of claim 10, wherein to reselect the secondary candidate cell is to reselect the secondary candidate cell on a same frequency as the target cell in response to intra-frequency reselection being allowed.

13. The processor of claim 10, wherein to reselect the secondary candidate cell is to reselect the secondary candidate cell on another frequency than the target cell in response to intra-frequency reselection not being allowed.

14. The processor of claim 10, wherein the processor fails to receive the SIB1 request configuration for the target cell due to at least one of not being able to acquire the SIB1 request configuration within a threshold amount of time, a current serving cell of the processor being neither a network energy saving (NES) cell nor an anchor cell, or receiving SIB1 request configurations for one or more cells of the multiple candidate cells other than the target cell.

15. The processor of claim 14, wherein the at least one controller is further configured to cause the processor to, in response to not receiving the SIB1 request configuration for the target cell, ignore the target cell until the SIB1 request configuration for the target cell is received or the SIB1 of the target cell is acquired.

16. The processor of claim 14, wherein the at least one controller is further configured to cause the processor to, in response to not receiving the SIB1 request configuration for the target cell, bar the target cell for future cell selection or reselection for a threshold amount of time.

17. The processor of claim 10, wherein the processor is unaware that the target cell provides the SIB1 on an on-demand basis, and the at least one controller is further configured to cause the processor to ignore the target cell until the SIB1 request configuration for the target cell is received or the SIB1 of the target cell is acquired.

18. The processor of claim 10, wherein the target cell comprises one of the multiple candidate cells having a highest ranking or a one of the multiple target cells in a higher priority frequency than a frequency of a current serving cell for the processor.

19. A method performed by a user equipment (UE) operating in a radio resource control (RRC) idle mode, the method comprising:
selecting from multiple candidate cells, a target cell to be a next serving cell for the UE;
starting, based on the target cell providing system information block 1 (SIB1) on an on-demand basis and in response to receiving a SIB1 request configuration for the target cell, a SIB1 request for the target cell based at least in part on the SIB1 request configuration for the target cell; and
reselecting, in response to receiving no SIB1 for the target cell in response to the SIB1 request, a secondary candidate cell of the multiple candidate cells on a same frequency as the target cell or on another frequency than the target cell based at least in part on whether intra-frequency reselection is allowed, and continue to consider the target cell in future cell selection or reselection evaluation.

20. The method of claim 19, wherein reselecting the secondary candidate cell comprises reselecting the secondary candidate cell on a same frequency as the target cell in response to intra-frequency reselection being allowed.
